(19) United States
(12) Patent Application Publication
(10) Pub. No.: US 2014/0059447 A1
(43) Pub. Date: Feb. 27, 2014

(54) Method and System for Mobile Walls

(71) Applicant: Veysel Berk, (US)

(72) Inventor: Veysel Berk, (US)

(21) Appl. No.: 13/592,121

(22) Filed: Aug. 22, 2012

(51) Int. Cl. G06F 3/048; G06F 15/16

(52) U.S. Cl. 715/751

(57) ABSTRACT

Wallit is a system of location-based digital canvases, namely “Walls”. These “Walls” are defined with a radius based on the location's geographic coordinates.

Content of “Walls” include text, pictures, photos, and videos, placed onto that “wall” by users of Wallit's mobile application or by businesses using Wallit's various web interfaces.

Ability of users and businesses to submit content to walls can vary based on where the point of submission is with respect to the Wall's location, on privileges of a user or business, or on time of submission. Display of content on Walls is also through Wallit's mobile application and web interfaces. Display of each piece of content can be accompanied by a profile depicting the submitter of content, and privileges of submitter or from which location the submission was made.

Content, their placements, and user privileges are subject to monetization by Wallit Inc. who maintains their control and order.

### FIELD

The present method and system relate generally to applications for mobile devices and, more particularly, to location-based social networking mobile applications and wall posting.

### BACKGROUND

People and friends are at the center of the existing social network paradigm including location-based mobile applications. Existing systems use location as a parameter to connect people.

Augmented reality (AR) is a term for a live direct or an indirect view of a physical, real-world environment whose elements are augmented by computer-generated sensory input such as sound, video, graphics or Global Positioning Sensor (GPS) data. It is widely used in mobile phone applications today, such as in the commonly known application “Wikitude”. As a result of augmented reality, one's current perception of surroundings is either enhanced or gains a different perspective.

### SUMMARY

The present system includes a mobile application that enables users to post messages and any relevant content (including multimedia) to persistent location- or concept-based augmented walls anonymously or with verified ID, and can be limited to only those users within certain proximity of the location. These walls may have temporal dimensions (time) in addition to its spatial dimensions (location). Moreover, these walls may be live objects and allow real-time communication between users and/or content delivery entities and platforms. This facilitates user engagement with the application and promotes interaction with others at a personal level. These walls may be rendered as live objects using augmented reality (AR) to give users a physical sense and persistent nature of the walls.

The present system uses location as a pivotal point and uses people, friends and other entities as parameters. This approach brings persistency to a location and allows people to connect through these persistent regions.

The present system enables users, using an application on a mobile device, to post messages on pre-defined/created virtual walls. The user has the option to use a verified identity, such as one from Facebook or Twitter, or to post anonymously. Each virtual wall has latitude, longitude and altitude, and a proximity radius definition. Only users within the proximity radius of the wall location can post messages, while messages can be viewed from anywhere. The user's location is detected by using the mobile device's sensors such as GPS, or in some instances, by using the geographic location of an IP address of the connecting device, such as laptops or desktops.

In posting on any of the pre-defined/created walls, users can input text; choose one of the available templates for special occasions such as marriage proposals or birthday celebrations; or post photos, other relevant content including multimedia.

Users can view posts on a wall through a user interface provided with the application, or an augmented reality option to view messages on a semi-transparent wall overlaying the camera view of the mobile device.

Users or businesses can post on the most visible or sponsored spots on the wall, by purchasing one of the advertisement packages for a specific wall, or by using or purchasing one of the templates for messages (such as a marriage proposal template).

Third parties may deliver a spatial-, temporal- or concept-based static or interactive content to these walls such as feedback surveys, information, dynamic retail pricing, etc. either manually or by using automated algorithms. Moreover, content created by users on the walls can be used to understand user/consumer behaviors at a point location accuracy and specification. Walls may behave in sync with other systems to deliver a synchronized content such as but not limited to display ads in sync with screen and billboards in a stadium.

### BRIEF DESCRIPTION

The accompanying drawings, which are included as part of the present specification, illustrate the presently preferred embodiment and, together with the general description given above and the detailed description of the preferred embodiment given below, serve to explain and teach the principles of the present invention.

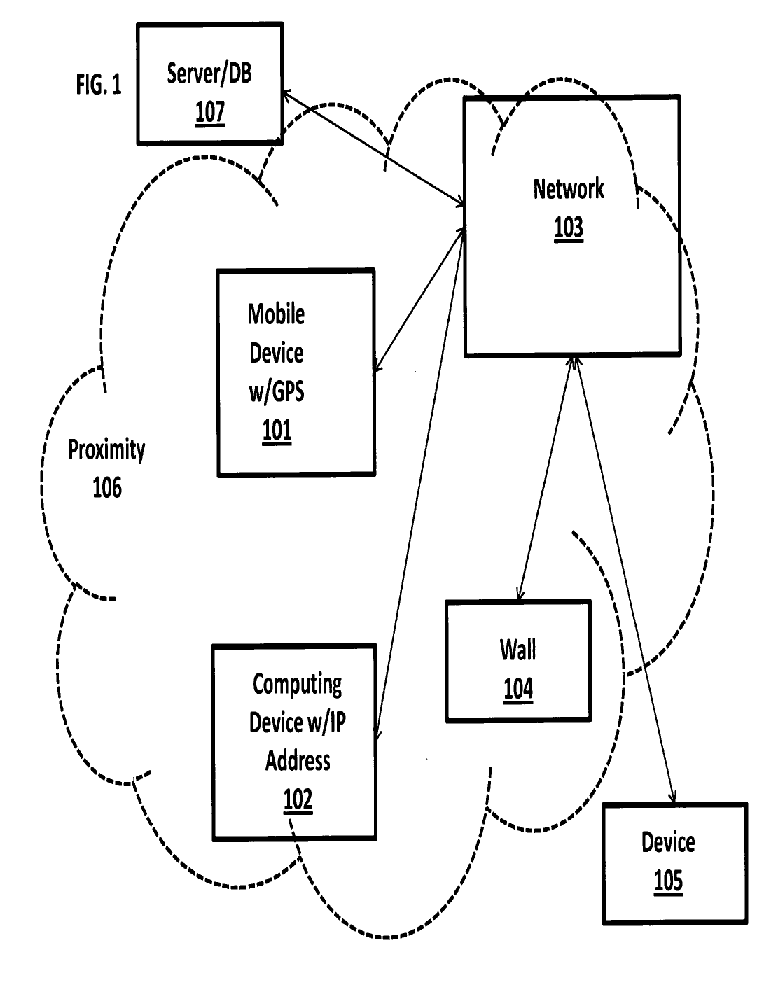

FIG. 1 illustrates an exemplary system level layout for use with the present system, according to one embodiment.

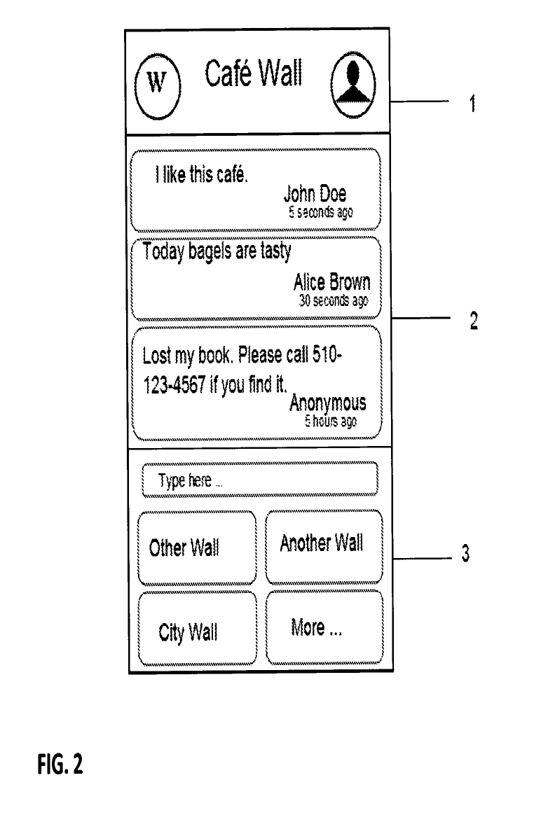

FIG. 2 illustrates an exemplary user interface for use with the present system, according to one embodiment.

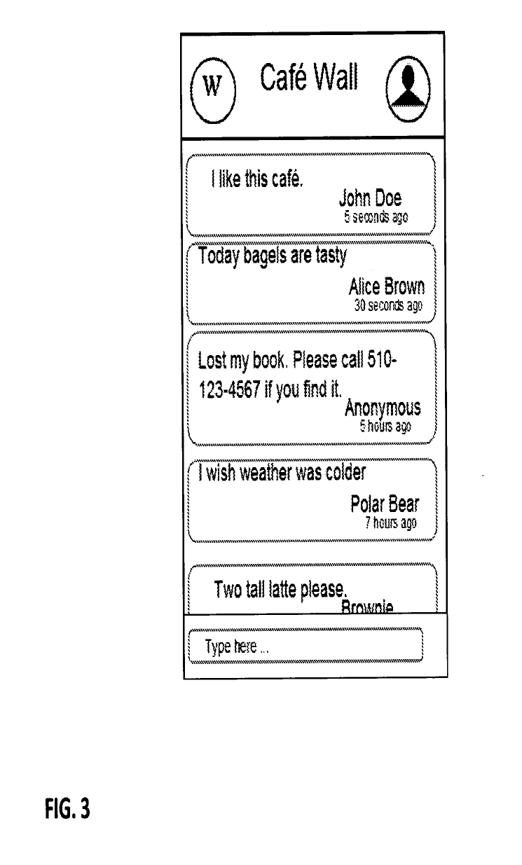

FIG. 3 illustrates another exemplary user interface for use with the present system, according to one embodiment.

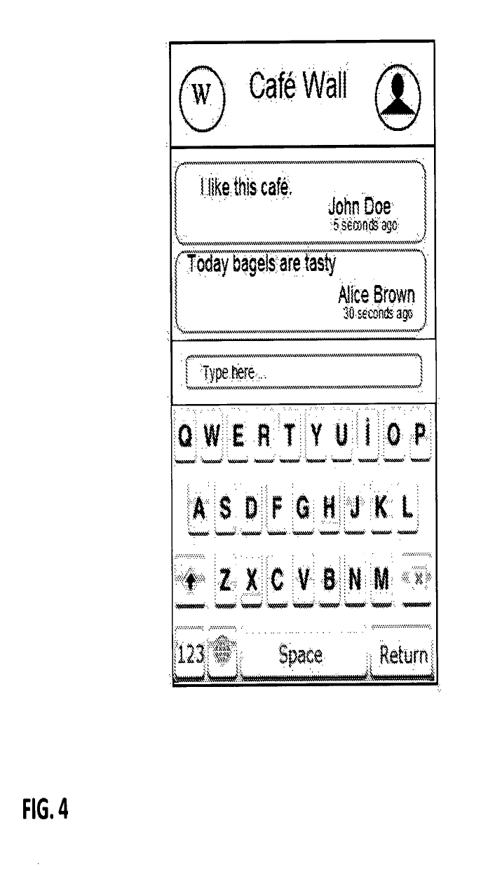

FIG. 4 illustrates an exemplary user interface including keyboard for use with the present system, according to one embodiment.

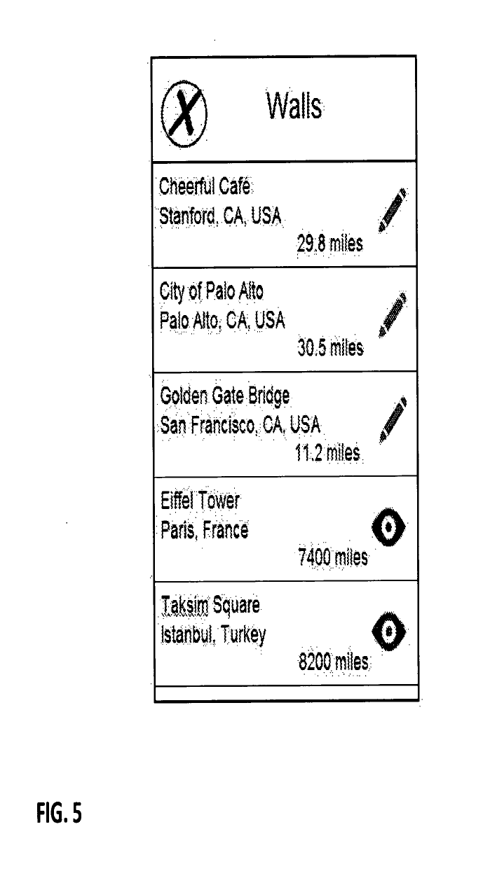

FIG. 5 illustrates an exemplary user interface including a list of walls for use with the present system, according to one embodiment.

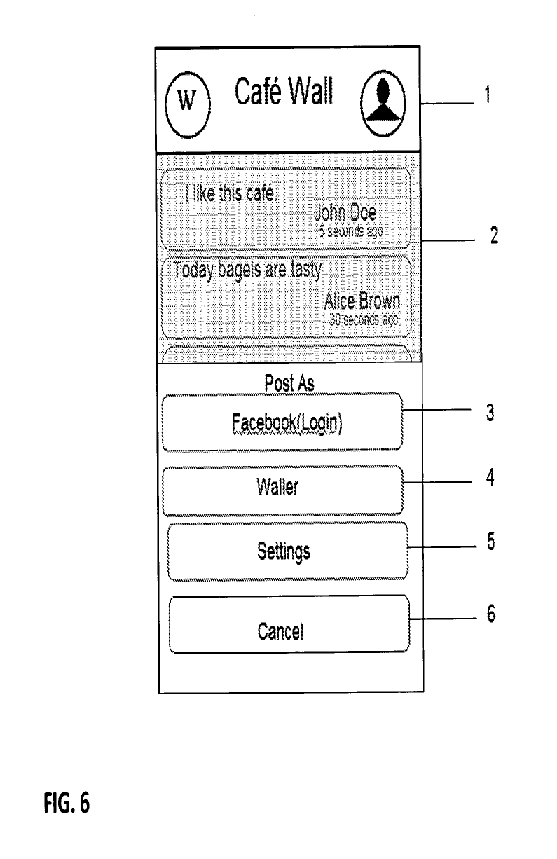

FIG. 6 illustrates an exemplary posting user interface for use with the present system, according to one embodiment.

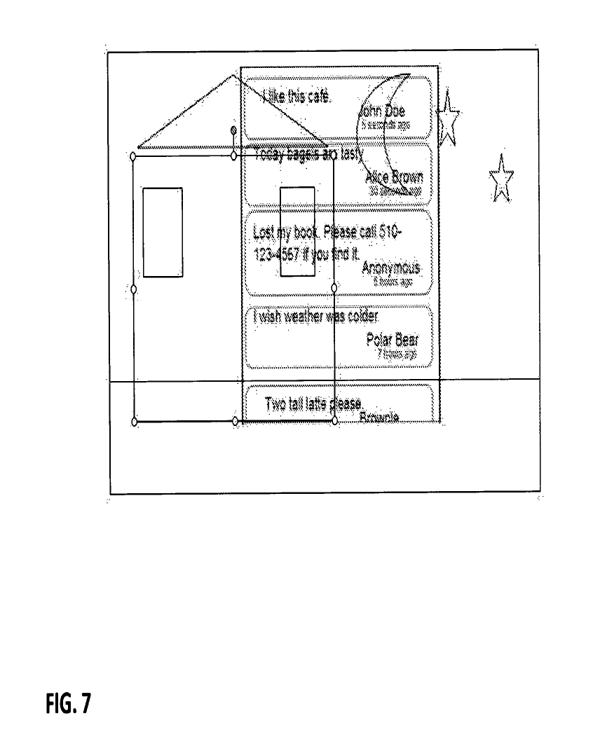

FIG. 7 illustrates an exemplary user interface including an augmented reality view for use with the present system, according to one embodiment.

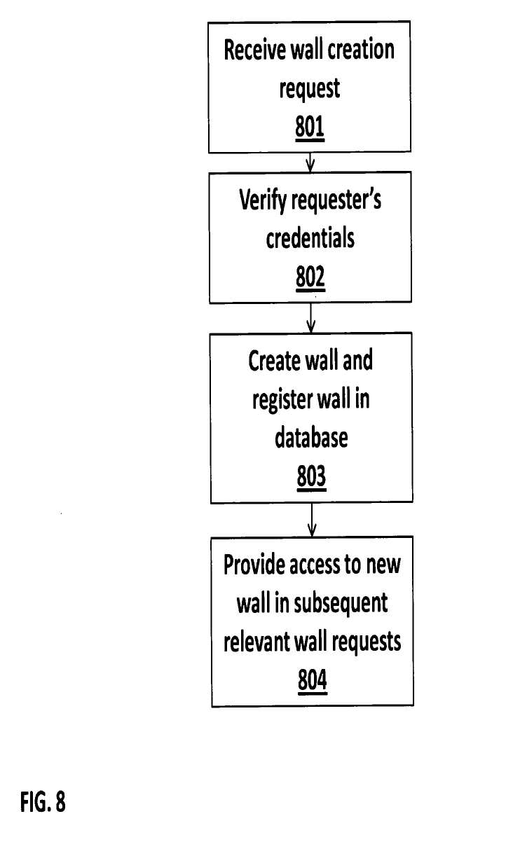

FIG. 8 illustrates an exemplary wall creation process for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DETAILED DESCRIPTION

According to one embodiment, the present system includes a mobile wall-posting application that defines and hosts a list of postings on a virtual wall. A wall is defined by its location (latitude, longitude, altitude), its proximity radius and may have temporal (time) dimension. The users can post content only from within the proximity radius, while users all around the world can view it (with the exception of post-on-certain-times (temporal dimension) walls described below). Rich content can be delivered to walls by users, third-parties and businesses in many different ways such as but not limited to automated algorithms, web-based interface, server connections, near-field communications, and mobile platforms.

FIG. 1 illustrates an exemplary system level layout for use with the present system, according to one embodiment. A server and database 107 in communication with a network 103 enables the creation and accessing of walls 104. A mobile device 101 in communication with the network 103 can view and post to a wall 104 as long as it is within a defined proximity 106 of the wall. A GPS associated with the mobile device 101 is used to determine whether the device 101 is within the proximity 106 of the wall 104. A computing device 102 in communication with the network 103 can also view and post to the wall 104 as long as it is within the proximity 106 of the wall 104. The IP address of the computing device 102 can be used to determine whether the device 102 is within the proximity 106 of the wall 104. A computing or mobile device 105, in communication with the network 103, that is not within the proximity 106 of the wall 104 can view the wall 104 but not post to it.

When a user invokes an application within the present system, the user elects to transmit their device location to the backend server of the present system. Software at the backend server takes the device location and returns to the device all walls within defined vicinity that the device can access (view and/or post to).

### Walls

Definition: A “wall” is the persistent entity associated with a certain geographic location or concept. The differentiating point of this wall-posting application is that “locations” are the pivotal points, not social profiles or people. Walls may have temporal (time) dimensions.

The function of a wall is to harbor the list of postings from users who have been able to access that wall, by being within a certain proximity radius of that wall, or via special access for certain locations on certain special days (such as the wall of Statue of Liberty on the 4^{th} of July Independence day). Certain walls may only be accessible at certain time of the days, months, years or any combination of time, location and concept. Walls may have static or interactive objects which can be used to enrich user experience as a part of games, social interactions, ads, dynamic retails pricing, location-based content delivery and any service that can be provided by walls and this application.

### Creation and Destruction of Walls

Walls can be pre-defined/created or defined/created real-time in a variety of ways including by users, businesses, automated-algorithms and system admins. Creators of walls and/or system admins may impose certain restrictions or customization to walls. Walls can be destroyed/removed from system temporally or permanently by creators, other users and/or system admins. Certain users may be given rights by the system admin to organize walls including destructions of walls. In certain cases, users may be able to rescue the walls, which are temporarily destroyed.

The number of walls grows over time, with the wall locations opened up gradually (locations with higher expected usage rates will be opened up earlier). The present system includes active management of the number of walls available.

To open up walls easily by category, the present system includes a database of walls, divided by category. The radius of walls can be different across different categories, e.g. small for a coffee shop while large for a stadium wall. Moreover, in a crowded downtown, radius needs to be short to accommodate a variety of walls in a compact space. On the other hand, the present system can elect only a single wall in a well-known tourist attraction, such as Golden Gate Bridge or Niagara Falls. In the latter case, the radius will be larger.

### Display of Walls

An important aspect of usability is how the walls are displayed to the user. This is important when user has dozens of walls in his/her vicinity. The wall-posting application will lists the walls according to proximity, popularity and other metrics, and can use a weighted average of those to score the walls. The user can always scroll down, or press “More” to see other walls (FIG. 2). The walls that are “editable” (i.e. user is close enough to write on) may have precedence over “read only” walls. The initial list of walls is also important for performance reasons—retrieving wall information for too many walls will take considerably longer, so it is important to keep the initial list as compact as possible.

When the mobile device is flipped horizontally, Augmented Reality (AR) mode (FIG. 7) automatically starts. AR view overlays the current wall or nearby walls in a semi-transparent fashion over the view from the camera. The present system also includes radar for showing the respective locations and direction of nearby walls.

### Privileged Sections of Walls and Virtual Billboards

In both the regular and augmented reality displays, the users or businesses may have their postings be displayed at an exclusive spot, or other such privileged, always visible placements on a certain wall. The posting party (user or business) has the option to claim this exclusive spot for a certain period of time, by paying related fees. Each wall may have nearby virtual billboards. These virtual billboards are like real billboards on the roads or shopping malls except that they are interactive and virtual. These virtual billboards interact with the main walls to improve user experience, engagement, visibility and usability of the content they deliver. Users, businesses and third-parties may deliver content to these virtual billboards by paying any necessary fees after agreeing the terms defined in the present system. These virtual billboards can be seen either in AR view or regular application view that can be activated by gestures such as swiping screen. Games and other rich interactive content can be embedded into these virtual billboards and walls.

Fees to utilize an exclusive spot on wall/billboards for a certain time depend on the audience size of the wall, the exclusivity of that spot, and the timing of the utilization. In general, the higher the user engagement on a wall (the more popular the wall), the more visible the spot, and the longer is the time frame, the higher the price will be. Web-based bidding or other scalable systems may be employed to rent these walls and billboards.

The exclusive spots may differ from wall to wall, and may not always be at the top. Other exclusive locations instead of or in addition to the top spot include (but are not limited to) sides, background, bottom, etc.

### Postings

There are two ways to display postings on the walls. One of them is via a regular display on the mobile device used (such as iPhone), and the other is via the augmented reality mode of the mobile device.

FIG. 2 illustrates an exemplary user interface for use with the present system, according to one embodiment. A user can tap on section 2 to remove section 3 from view (see FIG. 3), and provides expanded view of the messages. The screen refreshes periodically, with old messages sliding to the bottom, and new ones appearing at the top. The wall displayed as a sample is Cafe Wall in this instance. There are several postings by users visible on the screen, though scrolling down will show older postings as well. Each posting also has the user-chosen name or identity. Next to each identity is the time of the posting. When the user logs in (for example, using Facebook) a Facebook icon accompanies the posting name, such that public at large can understand this is a Facebook-verified identity.

The interface can also include a rating of posting, buttons to rate up or down, a report abuse/complain button (enables users to complain about certain users, slender/foul language, or inappropriate picture/videos accompanying the postings), and a reply button (to reply to a message directly; such a reply may be visible by everyone).

FIG. 4 illustrates an exemplary user interface including keyboard for use with the present system, according to one embodiment. Tapping on “type here” text box shows the keyboard. Typing a message and pressing on “Send” button returns to a default view, with the user's message appearing at the top.

FIG. 5 illustrates an exemplary user interface including a list of walls for use with the present system, according to one embodiment. Tapping on a “More . . . ” button results in the display of a larger list of walls. Near each wall, there is an indicator of whether this is a view-only wall (an eye sign) or writable by the user (pencil sign). As each wall has a proximity radius, only the walls that are close enough are writable.

FIG. 6 illustrates an exemplary posting user interface for use with the present system, according to one embodiment. Tapping on a “Post As” Icon (upper right) on any screen takes the user to the posting page. Section 2 (messages) dims. Button 3 takes user to a simple page (not shown) to log in with Facebook (or other social web site) credentials. Button 4 shows a post as name that the user chose previously. Button 5 takes the user to a page (not shown) where user can change the name that shows up on Button 4, read terms of use and privacy statements, and provide feedback through various means. After choosing a screen name, user is taken back to a default view.

FIG. 7 illustrates an exemplary user interface including an augmented reality view for use with the present system, according to one embodiment. When user flips the mobile device to horizontal view, augmented reality starts automatically, and a default view is overlaid upon camera view. AR mode only provides view into the messages. When user wants to interact with the wall, such as add a posting or rate one, the mobile devices shifts into a default view.

Postings from users or businesses may be static and/or dynamic content such as but not limited to text, images, audio or video files. A typical posting can include posting user or business name, time of post, and—if rated, rating of that posting based on community's votes.

Postings may also be classified under different headings such as classifieds, casual, help requests, comments, etc. These different posting categories may be accessible from different tabs or via the use of certain filters within mobile displays or from the web interfaces that may be created.

As postings may also contain inappropriate content, they are monitored and filtered for such offensive content. In addition to automatic filtering in place, the users are enabled to submit complaints about other users/posts. Defined policies block postings and users from posting or getting displayed publicly.

FIG. 8 illustrates an exemplary wall creation process for use with the present system, according to one embodiment. Walls can be created by system admin, users and third parties. This process can be invoked from mobile platforms, desktop systems or other network connected communication devices.

According to one embodiment, a wall can be created through a web based interface by manually entering wall name, longitude, latitude, altitude, time open for access, radius and other relevant information. Large databases of location files can also be uploaded to the system to create walls in bulk. Once the wall is created by web browser, a system server distributes the updated wall list to client systems such as mobile devices.

According to one embodiment, a wall can be created by a mobile device having stored thereon a software application associated with the present system.

According to one embodiment, when a wall creation function is invoked (either by a system admin or by a user), the a wall creation request is received 801. A wall creation request can include a wall name, longitude, latitude, altitude, time open for access, radius and other relevant information. Location information may be automatically obtained by a device's GPS, according to one embodiment.

The requester's credentials are checked to verify that the user has appropriate credentials to create a wall in the specified location 802. Wall creation at certain locations can be restricted to prevent wall inflation, duplication or any other reasons that a company may decide in order to practice its business.

Upon requester verification, the new wall is created and registered in the database 803. The database entry includes wall attributes such as location, radius, time open for access, and any other information included in the wall creation request.

When client devices communicate with the present system and request a list of walls, the new wall appears in relevant requests 804.

### Users

### Identity Revelation

According to one embodiment, users are anonymous by default. However, users may choose to post with a verified identity, or classify themselves as “business user”. Below are the specifics of each user type.

### a) Anonymous Users:

Users who simply post on a wall without creating a new profile or using a social network credential (such as for Facebook or Twitter), are classified as anonymous users. Unless they specify otherwise in the settings, their names are displayed in a generic anonymous manner. This category of users enjoys anonymity and has the ability to post quickly without identity verification.

### b) Verified Users:

Users electing to show that they have a unique identity, or who would like a convenient way to keep track of postings, may use their social network credentials, such as for Facebook or Twitter. Such users' postings have a small “verified user” icon displayed next to their posts, indicating that they are logged in via social network credentials. Under this scenario, messages by a user, if requested, automatically feed into the user's social network accounts. When user's location is known, user can also post messages on a wall using Twitter hash-tags (#w and similar) in their native Twitter clients.

### c) Businesses:

Businesses electing to post on walls, at locations devoted to them such as in exclusive spots as outlined above, create a business profile with the wall-posting application service. This ensures they can use the service and correctly represent their business identity when posting advertisements or deal announcements.

### Usage by Businesses

Businesses may claim, customize walls and deliver content to walls in their stores by registering with the present system and paying associated fees and accepting terms defined by the present system.

Advertising to and gathering feedback from consumers are among the mechanisms by which businesses benefit from the present system.

Businesses of any size can choose to post on certain walls at many or only a few specific locations, utilizing one or more of the exclusive spots available at their disposal.

With the flexible nature of the present system, businesses may also find other creative ways for engaging users with their products and services. For instance, walls created at a certain shopping mall, or even mini-walls created within a store like that of Wal-Mart or Target may allow businesses to direct consumers to targeted areas and provide direction for consumers seeking help. They may also choose to provide services like dynamic pricing stated on a wall, or other businesses may actually use the location of the walls as markers especially in some countries, such as those that may be needed for pole placement at regular intervals.

Businesses can deliver content to a specific wall. Businesses may choose to deliver regularly updated content for consumption to certain walls or parts of walls.

Walls created near businesses or at store locations also provide an invaluable mechanism to channel-in consumer feedback. For instance, businesses like Starbucks or Pete's Coffee benefit from such an implementation, and also get creative in offering deals on products or services in exchange for such an interaction with their consumers.

### Use Cases and User Engagement

Content Delivery: Business users can claim and use certain walls to publish content to certain walls, or parts of walls. This also increases user engagement.

Games: A treasure hunt that guides the user to a sequence of walls, gathering a clue at each wall, is a possibility. Another one is to seek answers about key questions about wall location, such as “when was this bridge built?” Non-monetary rewards, such as the ability to create wall at a location of user's choice, or a status (wall-nut) can be granted.

Deals: Especially in the vicinity of businesses, the business owners might be interested in posting deals periodically, such as “free coffee to first ten visitors”. A user community following such deals is provided.

Like/rate posts: The users can rate posts, and popular posts can be shown at the top in a wall, or in the web page. Wall of fame/wall of shame can be created with posts with highest/lowest ratings.

Multimedia attachments: Just as user can write text messages, users are able to post pictures, videos, and other rich/dynamic content, e.g. taken at the location of the wall, to share with friends.

Moon Wall and other walls in space and time domain (dimension): Since people can only write on nearby walls, a natural extension is to have a wall that everyone can write on. A moon wall is a wall that appears in the AR only after dark and when the user turns the camera to the moon. Writing to the moon has a special satisfaction, as everyone on earth will be able to see it. Special interest in writing on the moon is created by sending a push notification at a certain hour to the user, prompting him/her to look at the moon, to observe messages on the moon wall. This can be extended to cover any other objects in space and time. One natural consequence of this idea is to have walls for old civilizations on the earth.

Walls for dates, events and concepts: Just like walls for locations, we may create walls for special dates and events, such as World Cup final game, Presidential Election, Christmas 2011, etc. The walls are open only for certain duration of times, and messages are open to public.

Special occasions: On special days in which specific walls such as the wall at White House and/or Statue of Liberty will be open to posting from anywhere around the world or from the US on the 4^{th} of July (local time-temporal dimension). This way, people from around the world will be able to connect and share through the wall-posting application on a special day.

Personalization: the user is able to personalize the app screen, by presenting different choices of fonts, background pictures, skins, avatar pictures, and other settings that user can adjust.

Replies/conversations: An important aspect of communicating through messages is the ability to reply to/commenton a post, and starting a conversation. The present system supports a view that enables users continue such a conversation.

Search/filter capabilities: Especially at popular walls, there might be thousands of messages coming every minute. The interface of the present system scrolls down with new messages, but it may be impossible to catch up with the incoming message rate. In such cases, it is inevitable to do sampling; hence not all messages will appear. The user can search by keywords in messages, or filter by a poster name, to find what he or she is looking for.

Templates: There will always be popular categories of posts, such as birthday celebrations, marriage proposal, declarations of love or admiration, or just “leaving a flag”. For such popular categories, template posts are provided that user can customize (possibly in-app purchase) and post.

The present system includes multidimensional persistent walls with spatial (location) and temporal (time) dimension. Certain walls can only be accessed at certain locations and certain time period. For example, business x may customize the wall in its store to be accessible only in business hours, say 9:00 AM to 5:00 PM and the customer only within y (radius) yards may access the walls. The radius of accessibility also can be customized in addition to time.

According to one embodiment of the present system, walls can be created for special events or concepts.

According to one embodiment of the present system, walls can be created on any space including moon, starts and galaxies.

According to one embodiment of the present system, location-based content delivery to walls from third parties in addition to users is enabled.

According to one embodiment of the present system, interactive virtual billboards around walls can be rented by users, businesses and other third parties. Virtual billboards also interact with adjacent walls to improve user experience and visibility of billboards.

According to one embodiment of the present system, walls and virtual billboards can be visualized by augmented-reality.

According to one embodiment of the present system, social games are implemented to the core of walls such as but not limited to treasure hunting.

According to one embodiment of the present system, users can switch quickly between their verified IDs (social IDs such as Facebook) and anonymous IDs to post to the same wall. Although users can elect not to display their ID, the present system can still track their activity using their device ID and allow them to see and share their profiles with other users. For example, even a user post anonymously to wall-1 and with verified ID to wall-2, they may see and share with others that user posted on wall-1 and wall-2 without revealing their ID.

In the description above, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general-purpose systems, computer servers, or personal computers may be used with programs in accordance with the teachings herein, or it may prove convenient to construct a more specialized apparatus to perform the required method steps. The required structure for a variety of these systems will appear from the description above. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter.

A system and method for mobile walls have been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

I claim:

1. A computer-implemented method, comprising:
receiving a wall creation request, the wall creation request comprising a wall name, a longitude, a latitude, an altitude, a time window during which the wall is open for access, and an access radius; and
creating a wall entry in a database including the wall name, the longitude, the latitude, the altitude, the time window during which the wall is open for access, and the access radius.

2. A computer-implemented method, comprising:
receiving a location associated with a mobile device; and
providing for access to a wall by the mobile device upon confirmation that the location associated with the mobile device is within a access radius of the wall, wherein access includes at least one of viewing and posting to the wall.

3. A non-transitory computer-readable medium having stored thereon a plurality of instructions, the instructions when executed by a processor cause the processor to perform:
receiving a wall creation request, the wall creation request comprising a wall name, a longitude, a latitude, an altitude, a time window during which the wall is open for access, and an access radius; and
creating a wall entry in a database including the wall name, the longitude, the latitude, the altitude, the time window during which the wall is open for access, and the access radius.

4. A non-transitory computer-readable medium having stored thereon a plurality of instructions, the instructions when executed by a processor cause the processor to perform:
receiving a location associated with a mobile device; and
providing for access to the wall by the mobile device upon confirmation that the location associated with the mobile device is within the access radius of the wall, wherein access includes at least one of viewing and posting to the wall.
